(19) United States
(12) Patent Application Publication
(10) Pub. No.: US 2010/0230367 A1
(43) Pub. Date: Sep. 16, 2010

(54) LIQUID MEDIUM TREATMENT METHOD

(75) Inventors: Andrei Vjacheslavovich Nevedeev, Moscow (RU); Vladimir Danilovich Cherkas, Moscow (RU); Andrey Dmitrievich Zhukov, Moscow (RU); Anton Viktorovich Danilov-Daniljan, Moscow (RU)

Correspondence Address: HAYNES AND BOONE, LLP;IP Section, 2323 Victory Avenue, Suite 700, Dallas, TX, 75219, US

(73) Assignee: Rint Corporation, Moscow (RU)

(21) Appl. No.: 12/723,500

(22) Filed: Mar. 12, 2010

(30) Foreign Application Priority Data
Mar. 13, 2009 (RU) 2009109143/15(012

(51) Int. Cl. B01D 17/00; B01D 17/035; B01D 17/038

(52) U.S. Cl. 210/789

(57) ABSTRACT

The liquid treatment device comprises the nozzle with the throat, the confuser inlet chamber and the diffuser outlet chamber. The vortex cylinder with end-to-end cyclonic ports is coupled to the confuser chamber. The cavitation generator, the shaped head part of which is inserted in the nozzle, is secured axially to the said cylinder with possibility of axial travel. Axisymmetrical internal and external shells and correspondingly are built in the diffuser outlet chamber forming the annular channel in between. During treatment the liquid homogeneous mixture while passing through the cavitation zone is “heterogenized” by both wave slamming, generated with cavitation bubbles collapse, and by bubble generation. Partial “micro-cracking” takes place—bond opening with highly active radical and decreased molecular weight hydrocarbon generation.

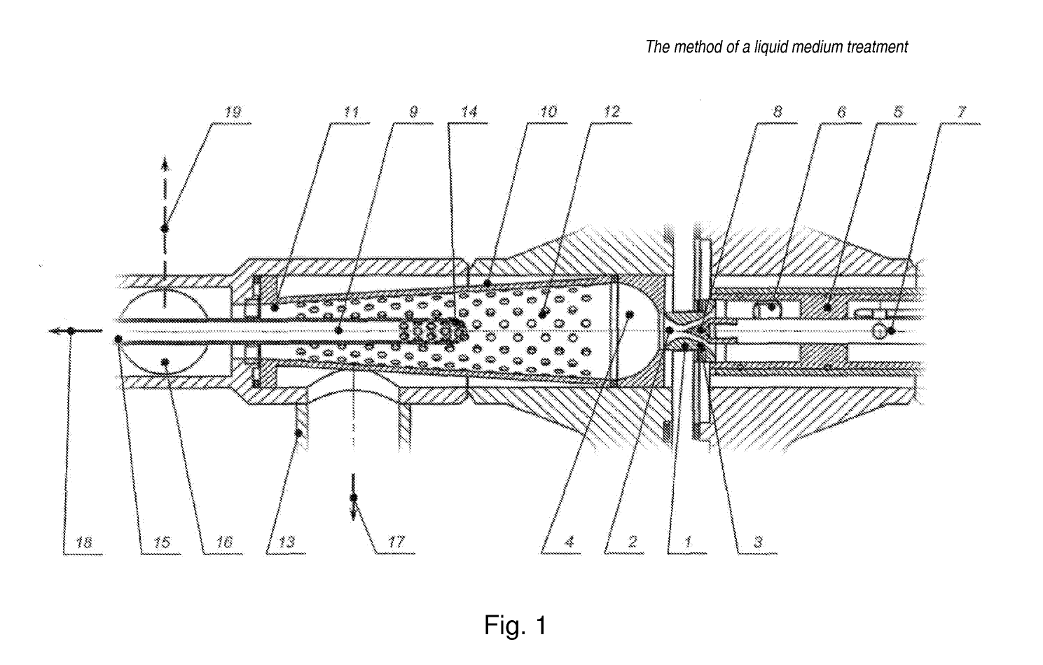

The invention relates to technology and equipment for liquid media treatment and disintegration and can be used in oil processing, chemical, medical and other industry branches.

The known method of a liquid medium treatment consists in that the liquid medium is pre-spun, its flow is passed to an annular channel and is delivered according to the process purpose (1).

The described method treatment is intended for the liquid homogenization improvement and it is outlet from the annular channel in form of a common flow.

The disadvantage of the said technical decision is activation of only mixing process and impossibility to disintegrate the liquid.

The nearest technical decision is the method of a liquid medium treatment consisting in that the liquid medium is pre-spun with a certain relationship of rotation and forward speeds depending on its treatment mode, is directed to a nozzle with a throat and a diffuser outlet chamber in a spiral type path with cavitation zones axial chain and the medium pressure set radial gradient is made in the nozzle (2).

As a result of both rotation and forward speeds values controlling and their relationship, depending on process conditions, both the liquid disintegration and mixing can be activated.

The disadvantage of the said technical decision is that in the liquid disintegration mode all disintegrated components are outlet in a common composition flow resulting in their partial mixing during outlet and passing into the mainstream flow thus degrading the liquid medium disintegration process. Besides later outlet of disintegrated components needs additional power consumption and complicated the process in general.

The purpose of the invention is a liquid medium disintegration process improvement, power consumption saving and process simplification in general.

The said purpose can be achieved so that in the known method of a liquid medium treatment consisting in that the liquid medium is pre-spun with a certain relationship of rotation and forward speeds depending on its treatment mode, directed to a nozzle with a throat and a diffuser outlet chamber in a spiral type path with cavitation zones axial chain and the medium pressure set radial gradient is made in the nozzle, in the medium disintegration mode the pressure gradient operating range geometrics value is determined, the liquid medium flow downstream is passed to an annular channel with the said pressure gradient operating range and simultaneously its partial controlled outlet from the formed annular channel both internal and external surfaces is provided with the liquid medium disintegration into autonomous component flows, herewith the value of the pressure in the nozzle radial gradient is maintained constant.

Besides the process flow from the formed annular channel can be added to the treated liquid medium and be repeatedly disintegrated.

In each specific case a specific treatment device is used depending on the treated liquid physical-chemical parameters and necessity to remove particular components from it.

The drawing schematically shows the device, in a particular case implementing the put forward method for liquid hydrocarbon mixture (oil and oil products) treatment in the course of disintegrated heavy fractions and light ends removing.

The liquid treatment device comprises a nozzle 1 with a throat 2, an inlet confuser chamber 3 and an outlet diffuser chamber 4.

A vortex cylinder 5 with end-to-end cyclonic ports 6 is coupled to the confuser chamber 3. In the general case prior to the nozzle 1 there can be located a moveable liquid rotation and forward speed relationship control, however while treating a specific liquid with known specified physical-chemical parameters it is more efficient to provide the needed speed relationship by profiles of both the nozzle 1 itself and the set geometrics vortex cylinder 5 as well as by their spatial orientations relative to each other for such liquid treatment.

A cavitation generator 7, the shaped head part 8 of which is inserted in the nozzle 1, is secured axially to the said cylinder 5 with possibility of axial travel.

Axisymmetrical internal and external shells 9 and 10 correspondingly are built in the diffuser outlet chamber 4 forming the annular channel 11 in between. The annular channel width and the shells 9 and 10 location as regard to both each other and the throat 2 is determined by set geometrics of the pressure gradient operating range for a specific treated liquid. The internal shell 9 edge can be made shaped. Generated components removal from the annular channel 11 outer side is made through perforation holes 12 of the external shell 10 and the connection pipe 13. Generated components removal from the annular channel 11 inner side is made through perforation holes 14 of the internal shell 9 and the connection pipe 15. The treated liquid is outlet from the annular channel 11 through the connection pipe 16. As a result autonomous process flows of components 17, 18 and 19 are generated. The process flow 19 from the annular channel 11 can be added to the treated liquid and directed to the nozzle 1 inlet for repeated disintegration. During the liquid treatment by the liquid itself supply speed control and by the cavitation generator 7 location the value of the pressure in the nozzle 1 radial gradient is maintained constant.

The put forward method of a liquid treatment is implemented as follows.

Preliminarily, prior to the liquid treatment, for example liquid hydrocarbon mixture, depending on their initial make-up and presence of any removed components, the necessarily shaped nozzle 1, the vortex cylinder 5 and the cavitation generator 7 are selected and installed at set relative positions, optimal for treatment of a specific initial mixture of liquid hydrocarbons. The liquid is supplied to the nozzle 1 inlet and while passing through the nozzle the flow is spun obtaining a spiral form. The cavitation generator 7 provides continuous cavitation single zones nucleation on its shear, which line up downstream treated flow in form of axial chain.

During treatment the liquid homogeneous mixture while passing through the cavitation zone is “heterogenized” by both wave slamming, generated with cavitation bubbles collapse, and by bubble generation, when the cavitation bubble volume is filled with easy volatile component vapors and on its surface less volatile components are concentrated, and originated inhomogeneity is kept after its collapse. Besides partial “micro-cracking” takes place—bond opening with highly active radical and decreased molecular weight hydrocarbon generation. The medium of the treated liquid flow is specifically disintegrated by constituent liquid phases and a composition of not bound with each other components is generated.

The rotational flow generated in the nozzle 1 cross-section the corresponding centrifugal force field resulting in generation of the pressure gradient from the flow axis to its periphery and in re-distribution of the disintegrated components in the flow, lighter ones to the centre and the heavier to its periphery. As a result the component composition in the flow separates in radial direction into layers in accordance with its specific weight and the treated liquid one or another component set with corresponding specific weights corresponds to each pressure radial value.

The entire pressure gradient acts from the nozzle axis to its walls, however depending on treated liquid hydrocarbon mixture physical-chemical parameters and on the removed components make-up the pressure operating levels, on which the needed list of components with corresponding specific weights is concentrated, have well defined values.

With continuous removal of any components from the annular channel 11 external and internal surfaces these surfaces will be fed with the corresponding components along the annular channel length from the annular composition flow, rotating within pressure gradient operating range characterizing the centrifugal force field in the annular channel 11 between pressure operating levels.

By selecting the nozzle 1, the cylinder 5 and the generator 7 design features as well as by setting the treated flow corresponding radial and forward speeds it is possible to provide certain volume of the cavitation zones and their intensity and accordingly the degree of cavitation effect on the liquid state and also well defined design radial value of the pressure operating levels and their location at the nozzle 1 axis as regard of the throat 2 and from here the pressure gradient operating range geometrics in general.

The perforated shells 9 and 10 location, each of which on the pressure operating level radial value, i.e. on the pressure operating gradient limits, at the set distance from the nozzle 1 throat, provides removal of the corresponding components from the operating levels through the perforations 12 and 14. Free components are removed for their purposes through the corresponding connection pipes 13 and 15 with generation of autonomous process flows 17 and 18. In the course of the process flows removal their rate is controlled and thus the pressure operating values are maintained and the liquid separation process itself by light and heavy components is optimized.

As a result light and heavy gas oils are removed from the treated liquid hydrocarbon mixture flow through process flows and heavy fractions are removed from oil products.

The process flow 19 removed from the annular channel 11 through the connection pipe 16 can be diverted for its purpose or added to the liquid treated flow to the nozzle 1 inlet for repeated treatment and deeper liquid separation by components.

Thus the put forward technical decision improved liquid medium separation by constituent components, saves power consumption for separation process and simplifies the process in general.

Information sources:

1. The Russian patent No. 2 259 872 M [symbol] K BO1J 19/10, published in 2005.

2. The Russian patent No. 2 220 767 M [symbol] K BO1J 19/10, published in 2004.

1. The method of a liquid medium treatment consisting in that the liquid medium is pre-spun with setting a specific rotation and forward speeds relationship depending on its treatment mode, supplied to a nozzle with a throat and a diffuser outlet chamber in a spiral-type path with cavitation zone axial chain and the medium pressure set radial gradient is provided in the nozzle characterized in that the pressure gradient operating range geometrics value is determined, the liquid medium flow downstream is directed to an annular channel with the said pressure gradient operating range and simultaneously its partial controlled removal from both inner and outer surfaces of the generated annular channel is provided with the liquid medium separation by autonomous component process flows, herewith the pressure in the nozzle radial gradient value is maintained constant.

2. The method of a liquid medium treatment according to claim 1 characterized in that the process flow from the generated annular channel is added to the treated liquid medium and repeatedly separated.
